(19) United States
(12) Patent Application Publication
(10) Pub. No.: US 2004/0256978 A1
(43) Pub. Date: Dec. 23, 2004

(54) Array comprising organic electronic devices with a black lattice and process for forming the same

(76) Inventors: Gang Yu, Santa Barbara, CA (US); Runguang Sun, Shanghai (CN); Jian Wang, Goleta, CA (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/840,807

(22) Filed: May 7, 2004

Related U.S. Application Data
(60) Provisional application No. 60/473,868, filed on May 27, 2003.

(51) Int. Cl. H05B 33/00

(52) U.S. Cl. 313/501; 313/504; 313/506

(57) ABSTRACT

An array of electronic devices has an improved contrast ratio by lowering background luminescence from ambient radiation source(s). Background luminescence may be lowered by using a black lattice by itself of in combination with a black layer used between openings in the black lattice. The black lattice, black layer, or both may be achieved by using a high absorbance material, a low reflectivity layer, or a combination of the two. The low reflectivity layer may be designed by optimizing the thickness or materials at the interfaces of the layer to reduce reflectivity. A combination of the black lattice and a black layer within at least one set of the electrodes may provide very low background luminescence while still maintaining a good ratio of ON luminescence versus OFF luminescence.

### FIELD OF THE INVENTION

This invention relates in general to electronic devices, and more particularly, to an array of organic electronic devices having improved contrast characteristics.

### DESCRIPTION OF THE RELATED ART

Organic (small molecule or polymer) electroluminescent devices or light-emitting diodes (OLEDs) are promising technologies for flat panel display applications. OLEDs typically include a plurality of electronic device layers including an anode layer, an active layer, and a cathode layer, and may include an optional hole-transport layer, an electron-injection layer, or both. However, they are not without problems. In OLEDs, the cathode is usually made of low work function metals, such as Mg—Ag alloy, Al—Li alloy, Ca/Al, Ba/Al LiF/Al bilayers, and the like, and has mirror-like reflectivity if its thickness is over 20 nanometers. The high reflectivity of the cathode results in poor readability or low contrast of the devices in lighted environments.

An attempt to solve the reflection problem is to place a circular polarizer in front of the display panel. However, circular polarizers block about 60% of the emitted light from the OLED and increase module thickness and cost considerably. The polarizer is typically located such that the substrate lies between the polarizer and the OLED.

Another attempt in improving display contrast uses an interfering mechanism as an additional layer within an electronic device. The high contrast interference films lie between an organic light-emitting layer and either of the anode layer and the cathode layer. The interfering mechanism is limited to a pre-selected wavelength. The actual contrast ratio of the device not only depends on the ambient light, but also on the emitting light of the device itself. The integration of such technology in a full color display and making the final product work in variable environments prove to be difficult. The interference film also adds manufacturing complexity and reduces yields. Such complications and performance degradation are undesirable.

Still another attempt to improve display contrast includes using a light absorbing material between pixels of an electroluminescent display, wherein the light absorbing material effectively lies within the substrate. However, light-absorbing materials at such a location (within the substrate) may not provide optimal contrast.

### SUMMARY OF THE INVENTION

An array of electronic devices has an improved contrast ratio by lowering background luminescence from ambient radiation source(s). Background luminescence may be lowered by using a black lattice by itself or in combination with a black layer used between openings in the black lattice. The black lattice, black layer, or both may be achieved by using a high absorbance material, a low reflectivity layer, or a combination of the two. The low reflectivity layer may be designed by optimizing the thickness or materials at the interfaces of the layer to reduce reflectivity. A combination of the black lattice and a black layer within at least one set of the electrodes closest to the user of the array may provide very low background luminescence while still maintaining a good ratio of ON luminescence versus OFF luminescence.

In one set of embodiments, an array of electronic devices can comprise anodes lying at a first elevation, cathodes lying at a second elevation, and an organic active material lying between the anodes and cathodes. The array can also comprise a high absorbance material lying at any elevation from the first elevation to the second elevation. Ideally, the high absorbance material absorbs 100% of the radiation at a targeted wavelength or within a targeted spectrum. Still, high absorbance can be less than 100% and still achieve the desired effect of improving the contrast ratio.

In another set of embodiments, an array of electronic devices can comprise anodes lying at a first elevation, cathodes lying at a second elevation, and an organic active material lying between the anodes and cathodes. The array can also comprise a feature lying at any elevation from the first elevation to the second elevation. When using the experimental set-up and procedures detailed in “Flat Panel Display Measurements Standard” by the Video Electronics Standards Association Display Metrology Committee, the array can have an Ambient Contrast Ratio that is at least approximately 50% higher compared to the same array without the feature.

In a further set of embodiments, an array of electronic devices can comprise anodes at a first elevation, cathodes at a second elevation, and an organic active material lying between the anodes and cathodes. The array can also comprise a black lattice. The anodes or cathodes may include a black layer lying at substantially the same elevation as the black lattice.

In still further embodiments, processes can be used to form any or all of the arrays as previously described.

The foregoing general description and the following detailed description are exemplary and explanatory only and are not restrictive of the invention, as defined in the appended claims.

### BRIEF DESCRIPTION OF THE DRAWINGS

The invention is illustrated by way of example and not limitation in the accompanying figures.

FIG. 1 includes an illustration of how radiation may be reflected or transmitted by layers and at interfaces between the layers.

FIG. 2 includes an illustration of a plan view of a black lattice that includes openings for pixels.

FIG. 3 includes an illustration of a cross-sectional view of a portion of the black lattice within FIG. 2 showing how the black lattice may reduce the amount of ambient radiation re-emitted from an electronic device and may reduce cross talk between pixels.

FIG. 4 includes an illustration of a cross sectional view of an organic electronic device to show some potential locations for the black layer.

FIG. 5 includes an illustration of a cross-sectional view of an organic electronic device that includes electrodes that incorporate black layers.

FIG. 6 includes an illustration of a plan view of locations of the black lattice with respect to electrodes for passive matrix and active matrix displays.

FIG. 7 includes an illustration of a plan view of other structures that can be used for the black lattice.

FIGS. 8-13 include illustrations of views of a portion of an array of organic electronic devices in accordance with one set of embodiments.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

Reference is now made in detail to the exemplary embodiments of the invention, examples of which are illustrated in the accompanying drawings. Wherever possible, the same reference numbers will be used throughout the drawings to refer to the same or like parts (elements).

An array of electronic devices has an improved contrast ratio by lowering background luminescence from ambient radiation source(s). Background luminescence may be lowered by using a black lattice by itself or in combination with a black layer used between openings in the black lattice. The black lattice, black layer, or both may be achieved by using a high absorbance material, a low reflectivity layer, or a combination of the two. The low reflectivity layer may be designed by optimizing the thickness or materials at the interfaces of the layer to reduce reflectivity. A combination of the black lattice and a black layer within at least one set of the electrodes may provide very low background luminescence while still maintaining a good ratio of ON luminescence versus OFF luminescence.

Before addressing details of embodiments described below, some terms are defined or clarified. As used herein, the terms “array,” “peripheral circuitry” and “remote circuitry” are intended to mean different areas or components. For example, an array may include a number of pixels, cells, or other electronic devices within an orderly arrangement (usually designated by columns and rows) within a component. These electronic devices may be controlled locally on the component by peripheral circuitry, which may lie within the same component as the array but outside the array itself. Remote circuitry can control the array by sending signals to or receiving signals from the array (typically via the peripheral circuitry).

The term “black” when used to modify a layer or material depends on the location within the device and is not meant to denote or connote a specific color. Within a pixel, when the black layer or material lies between an organic active layer and a user side of the device, the black layer or material has low reflectivity of radiation at a targeted wavelength or spectrum. At all other locations, such as surrounding all or part of a pixel (from a plan view) or lying on a side of the organic active layer opposite the user side, the black layer or material transmits no more than approximately 10% of radiation at a targeted wavelength or spectrum.

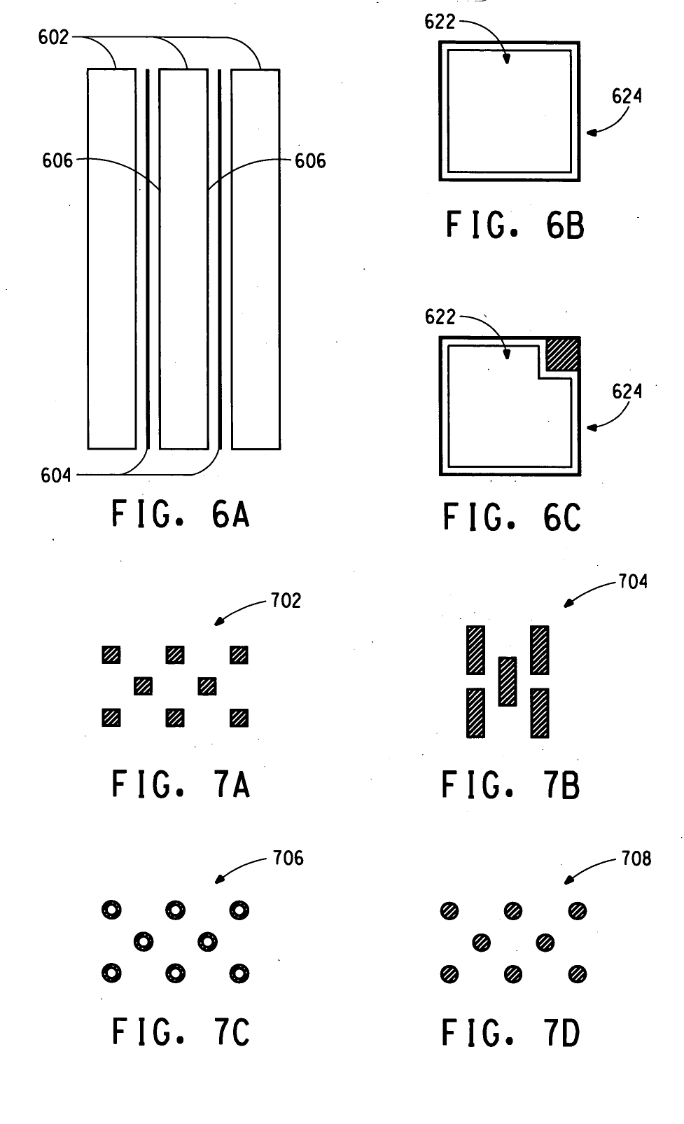

“Black lattice” is a patterned black layer that, from a plan view, surrounds at least part of a pixel. See FIGS. 2 and 6 and their related text.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “electron withdrawing” is synonymous with “hole injecting.” Literally, holes represent a lack of electrons and are typically formed by removing electrons, thereby creating an illusion that positive charge carriers, called holes, are being created or injected. The holes migrate by a shift of electrons, so that an area with a lack of electrons is filled with electrons from an adjacent layer, which give the appearance that the holes are moving to that adjacent area. For simplicity, the terms holes, hole injecting, and their variants will be used.

The term “elevation” is intended to mean a plane that is substantially parallel to a reference plane. The reference plane is typically the primary surface of the substrate from which at least a portion of the electronic device is formed.

The term “essentially X” is intended to mean that the composition of a material is mainly X but may also contain other ingredients that do not detrimentally affect the functional properties of that material to a degree at which the material can no longer perform its intended purpose.

The term “high absorbance” when used to modify a layer or material is intended to mean no more than approximately 10% of the radiation at the targeted wavelength or spectrum is transmitted through the layer or material.

The term “low L_{background}” is intended to mean no more than approximately 30% of the ambient light incident on the device is reflected from the device using the Ambient Contrast Ratio test (discussed later in this specification).

The term “low work function material” is intended to mean a material having a work function no greater than about 4.4 eV. The term “high work function material” is intended to mean a material having a work function of at least approximately 4.4 eV.

The term “most” is intended to mean more than half.

The term “user side” of an electronic device refers to a side of the electronic device adjacent to the transparent electrode and principally used during normal operation of the electronic device. In the case of a display, the side of the electronic device seen by a user would be a user side. In the case of a detector or voltaic cell, the user side would be the side that principally receives radiation that is to be detected or converted to electrical energy. Note that some devices may have more than one user side.

Group numbers corresponding to columns within the periodic table of the elements use the “New Notation” convention as seen in the CRC Handbook of Chemistry and Physics, 81^{st} Edition (2000).

To the extent not described herein, many details regarding specific materials, processing acts, and circuits are conventional and may be found in textbooks and other sources within the organic light-emitting diode display, photodetector, and semiconductor arts.

Before turning to the embodiments, some optical principles are addressed to improve clarity of the description. To quantitatively characterize the contrast of OLED devices, Contrast Ratio, “CR”, is introduced using the following equation

$$CR = \frac{{L}_{ON} + {L}_{background}}{{L}_{OFF} + {L}_{background}} \qquad ( Equation 1 )$$

L_{ON} is the luminance of a turned-on OLED device and is generally set at 200 Cd/m². L_{OFF} is the luminance of an off OLED device. L_{background} is the reflected ambient light from the device. CR is dependent on the luminance of the surroundings. For a bright environment, e.g. under direct sun, the contrast ratio is lower than that measured under low-light conditions. In the flat panel display industry, two standard tests are used for the contrast ratio. One is the Dark Room Contrast Ratio, and the other is the Ambient Contrast Ratio. The experimental set-up and procedures are detailed in “Flat Panel Display Measurements Standard” by the Video Electronics Standards Association Display Metrology Committee (“VESA”). In the following examples, the contrast ratios referred to within this specification are obtained using the conditions set in the Ambient Contrast Ratio test. By using a black lattice or a combination of a black lattice and a black layer, CR can improve by at least approximately 50% compared to the CR of the same array without the black lattice or combination.

Contrast can be improved by getting L_{background} as close to zero as possible. In one embodiment, the electronic device may have L_{background} that is no more than approximately 30% of the incident ambient light, L_{incident}, reaching the device. In other embodiments, L_{background} may be only approximately 10% or even 1% percent of L_{incident}. One way to reduce L_{background} is to use materials that absorb as much ambient radiation as possible, reflect as little ambient radiation as possible, or use a combination of high absorbance and low reflectance. Note that the electronic device may include many different layers, and therefore, each of the layers individually or in any combination may need to be examined.

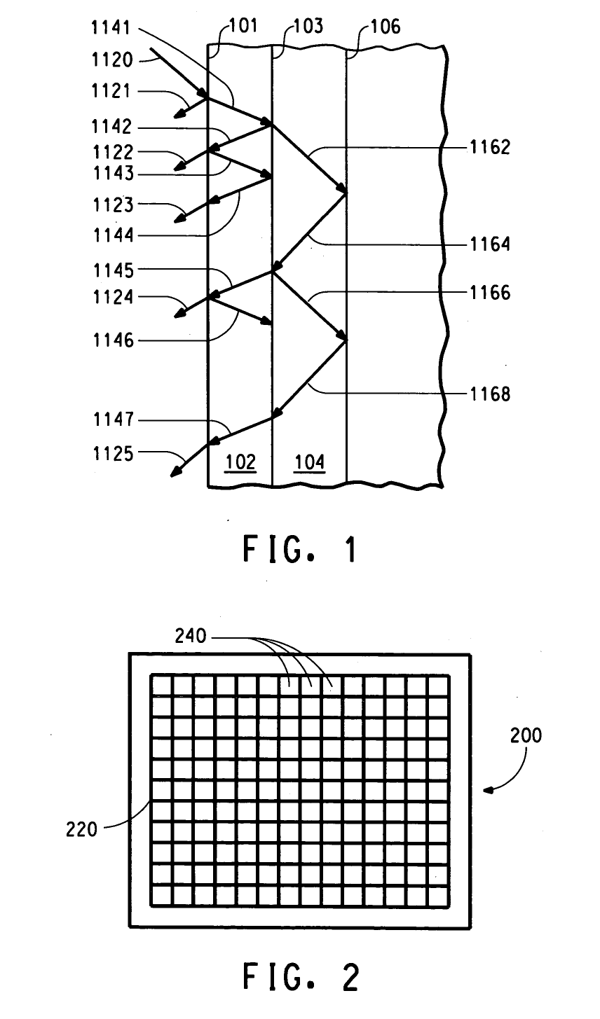

FIG. 1 illustrates the concepts of absorbance and reflectance. FIG. 1 includes a first layer 102, a second layer 104, and a mirror-like surface 106. Incident radiation 1120, L_{incident}, may be reflected at surface 101 as radiation 1121, or be at least partially transmitted, illustrated as radiation 1141. At the interface 103 between the first and second layers 102 and 104, radiation 1141 may be reflected towards surface 101 as radiation 1142. Radiation 1142 may be transmitted out of the device as radiation 1122 or reflected at surface 101 as illustrated as radiation 1143, which may be reflected at interface 103 as radiation 1144 and emitted as radiation 1123. Although not shown, some of radiation 1143 is at least partially transmitted though layer 104. The radiation can continue to pass along layer 102 similar to a waveguide but such radiation is not shown in FIG. 1.

Note that at least some of the radiation is absorbed by layer 102 each time it passes through the layer. Also, some of the radiation reaching interface 103 can enter layer 104. Therefore, radiation 1121 has a greater intensity than radiation 1122, which has a greater intensity than radiation 1123. The significance of the diminished intensity will be addressed later in this specification.

Continuing with FIG. 1, at least part of radiation 1141 may be transmitted through the layer 104, illustrated as radiation 1162. Because radiation 1162 reaches the mirror-like surface 106, nearly all radiation that reaches the surface 106 is reflected as shown by radiation 1164. At the interface 103, part of radiation 1164 may be reflected as shown by radiation 1166 or transmitted through the layer 102 as shown by radiation 1145. Similar to the layer 102, the layer 104 may act as a waveguide and include radiation 1166, 1168, and other radiation, not shown.

Some of the radiation that is transmitted through layer 102 (shown by arrows 1145 and 1147) may be emitted as shown by radiation 1124 and 1125. Part of radiation 1145 is reflected at surface 101 as illustrated by arrow 1146. Note that the “bouncing” of the radiation within a layer and transmission or emission from a layer can continue but is not shown in FIG. 1.

If only absorbance of layer 102 is considered, reflected radiation 1121 may be too high. If only low reflectivity of the first layer 102 is considered, radiation passing through the second layer 104 and reflected by surface 106 and re-emitted from the device (see radiation 1141,1162, 1164, 1145, and 1124) may be too high. Therefore, both reflectivity and absorbance for all layers may be considered to ensure that L_{background can be minimized.}

Absorbance of a layer having a substantially uniform composition can be empirically determined and data from absorbance (or transmittance) measurements collected from the empirical tests can be used to generate an equation for absorbance as a function of thickness. Each material may have its own absorbance equation as a function of thickness. Note that absorbance and transmittances are complementary mechanisms. Radiation that initially enters a layer may have some the radiation absorbed and the rest of the radiation transmitted. Therefore, skilled artisans may use transmission concepts rather than absorbance concepts. Therefore, a high absorbance material has low transmission at the targeted wavelength or spectrum.

Reflectivity or a range of thicknesses to be used for a single layer can be determined by the equation below.

2ηd cos(θ)+φ=(m+½)/λ (Equation 2)

wherein,

η is the refractive index of the selected material at a specific wavelength (λ);

d is the thickness of the layer;

θ is the angle of incident radiation;

φ is the total phase change of the radiation reflected by an ideal reflector at λ;

m is an integer; and

λ is the specific wavelength.

Equation 2 can be used to determine the appropriate thickness(es) for a layer. Equation 2 is a sinusoidal function of thickness. Therefore, multiple thicknesses can be used to attain low reflectivity for a specific wavelength. Equation 2 may be used for radiation outside the visible light spectrum, such as infrared or ultraviolet radiation.

For the visible light spectrum, 540 nm may be used for a specific wavelength for determining an appropriate thickness of a low reflectivity layer, and a metal mirror can be used as an ideal reflector. Clearly, other wavelengths can be used depending on the radiation being contemplated. Theta may be selected to be approximately 45 degrees.

Although the calculations can give a single thickness, typically a range of acceptable thicknesses may be given for manufacturing reasons. For example, the thickness may be ±10% of d in Equation 2. Alternatively, two equations may be used to determine lower and upper limits on d. For example, θ may be replaced 0-200 for one of the limits on the thickness, and θ may be replaced θ+20° for the other limit on the thickness. As long as the thickness does not lie outside the range, reasonably acceptable low reflectivity may be achieved. After reading this specification, skilled artisans will appreciate that other numbers or approaches could be used to determine limits on thicknesses.

The reflectivity of each interface between adjacent layers can be determined by the equation below.

$$R = \frac{{I}_{reflected}}{{I}_{incident}} = {( \frac{{η}_{x} - {η}_{y}}{{η}_{x} + {η}_{y}} )}^{2} \qquad ( Equation 3 )$$

wherein,

ηₓ and η_{y} are the refractive indices of the materials on opposite sides of the interface.

A series of equations for each of the layers and interfaces can be written using the absorbance (for each pass through each layer), the single layer reflectivity (Equation 2) and the interfacial reflectivity (Equation 3) equations. In theory, the number of equations may be very large. However, some simplifying assumptions may be made. For example, each of radiation 1121 and 1122 may be significant compared to radiation 1123. Therefore, radiation 1123 may be ignored. Similarly, radiation 1124 and 1125 may be significant, whereas, the “next reflection” (not shown in FIG. 1) from layer 104 being emitted from the device may be insignificant. Further, mirror-like surface 106 may be assumed to reflect all radiation reaching it. If surface 106 is black, it may absorb all radiation.

A computer program using the equations and simplifying assumptions may be run to determine how the L_{background} is affected by the thickness of any one or more layers or by changing the composition of the layers. L_{background} can be the sum of radiation 1121-1125. Note that radiation 1121-1125 may have different intensities and different phases. By changing the thickness(es) and composition(s) of the layer(s), the intensities and phases can be changed to cause destructive interference to reduce L_{background}.

As an alternative to the equations above, any combination of reflectivity and absorbance equations may be used. Many devices may have several layers instead of the two shown in FIG. 1. The equations may only focus on one layer or a subset of the layers. After reading this specification, skilled artisans will appreciate the types and number of equations to be used.

The concepts described herein can be used to determining compositions and thicknesses to achieve black layers or a black lattice. The black feature(s), whether black lattice(s) or black layer(s), could be inserted anywhere within the devices, e.g. at the same elevation as the electrodes, at an elevation between the electrodes and organic layers, or at an elevation between organic layers.

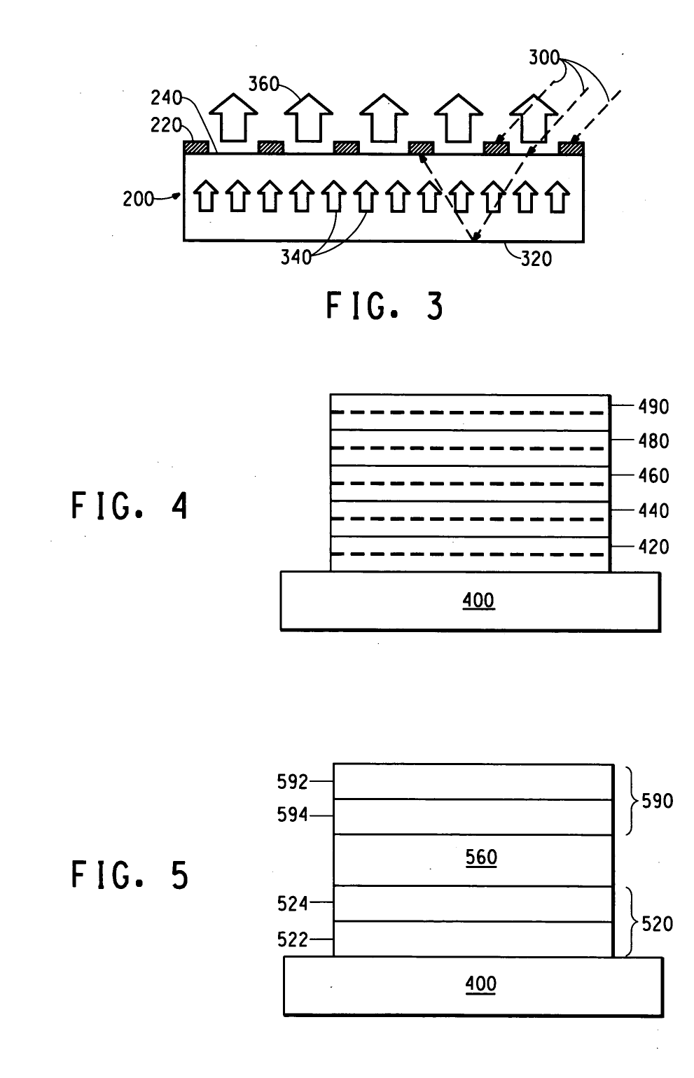

FIGS. 2 and 3 illustrate how a black lattice can be used in one embodiment that is optimized for absorbing ambient light. FIG. 2 includes an illustration of a plan view of an array 200 of pixels (electronic devices) having a black lattice 220. Pixels can emit light through the openings 240 within the black lattice 220. FIG. 3 includes an illustration of a cross-sectional view of a portion of array 200 shown in FIG. 2. Some of the incident ambient light 300 is absorbed by the black lattice 220. Other portions of the ambient light 300 is reflected off a surface 320 within the array 200 and absorbed by a different part of the black lattice 220. Light 340 from the pixels can pass through openings 240 in the lattice 220 as emitted light 360.

FIG. 4 shows that the black lattice may be formed at almost any elevation over a substrate 400 within a device. More specifically, the black lattice (illustrated by the black dashed lines) may be formed at the anode elevation 420, hole-transport elevation 440, organic active layer elevation 460, electron-transport elevation 480, or the cathode elevation 490.

FIG. 5 includes an illustration where a black layer may be used as part of the anode or cathode. An organic electronic device may include the substrate 400, an anode 520, and organic active layer 560, and a cathode 590. Although not shown, a hole-transport, an electron-transport, or other optional layer(s) may be present. The anode 520 may include a conductive black layer 522 and a high work function material 524, and the cathode 590 may include a low work function material 594 and a conductive black layer 592. Note that the black layers 522 and 592 are the furthest from the organic active layer 560 and one or both may be closest to the user side(s) of the array. Note that the black layers 522 and 592 may be designed to have low reflectivity so that a significant portion of the radiation to be emitted or detected by the device can pass through the black layer.

FIG. 6 includes an illustration of exemplary designs of the black lattice for use with a passive matrix and an active matrix device. In a passive matrix device (FIG. 6A), the electrodes (anodes or cathodes) may be part of conductive strips 602. The strips 602 have opposing sides 606 and the portions of the black lattice 604 are substantially parallel to the opposing sides 606. In FIG. 6A, the black lattice 604 lies between the pixels in the same row but not the same column. Note that the orientation of the strips 602 and portions of the black lattice 604 could be rotated by 90%, in which case, the black lattice 604 lies between the pixels in the same column but not the same row.

For active matrix devices (FIGS. 6B and 6C), electrodes 622 (such as anodes) may be in the form of pads instead of strips. In this embodiment, black matrices 624 may laterally surround the electrodes 622 on all sides (FIG. 6B), and may additionally protect the drive circuitry from radiation (FIG. 6C). Other designs are possible, and only some are describe herein to illustrate and not limit the invention.

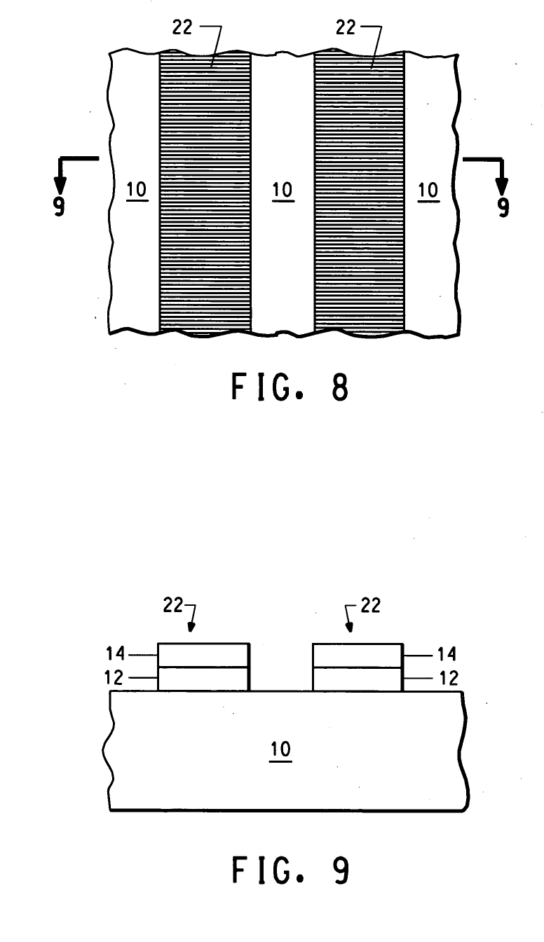

FIG. 7 illustrates that a number of different designs may be used. For example, squares 702, rectangles 704, rings 706, and circles 708 may be used instead of straight, continuous, solid lines. May other designs are possible, and only some are describe herein to illustrate and not limit the invention.

A nearly limitless number of materials can be used for a black lattice or layer. Its electrical characteristics can vary from conductive to semiconductive to insulating. A potential material for a black lattice or layer can comprise one or more inorganic materials selected from elemental metals (e.g., W, Ta, Cr, In, or the like); metal alloys (e.g., Mg—Al, Li—Al, or the like); metal oxides (e.g., CrₓO_{y}, FeₓO_{y}, In₂O₃, SnO, ZnO, or the like); metal alloy oxides (e.g., InSnO, AlZnO, AlSnO, or the like); metal nitrides (e.g., AlN, WN, TaN, TiN, or the like); metal alloy nitrides (e.g., TiSiN, TaSiN, or the like); metal oxynitrides (e.g., AlON, TaON, or the like); metal alloy oxynitrides; Group 14 oxides (e.g., SiO₂, GeO₂, or the like); Group 14 nitrides (e.g., Si₃N₄, silicon-rich Si₃N₄, or the like); and Group 14 oxynitrides (e.g., silicon oxynitride, silicon-rich silicon oxynitride, or the like); Group 14 materials (e.g., graphite, Si, Ge, SiC, SiGe, or the like); Group 13-15 semiconductor materials (e.g., GaAs, InP, GalnAs, or the like); Group 12-16 semiconductor materials (e.g., ZnSe, CdS, ZnSSe, or the like); any combination thereof, and the like. An elemental metal refers to a layer that consists essentially of a single element and is not a homogenous alloy with another metallic element or a molecular compound with another element. For the purposes of metal alloys, silicon can be considered a metal. In many embodiments, a metal, whether as an elemental metal or as part of a molecular compound (e.g., metal oxide, metal nitride, or the like) may be a transition metal (an element within Groups 3-12 in the Periodic Table of the Elements) including chromium, tantalum, gold, or the like.

A potential material for a high absorbance layer can comprise one or more organic materials selected from polyolefins (e.g., polyethylene, polypropylene, or the like); polyesters (e.g., polyethylene terephthalate, polyethylene naphthalate or the like); polyimides; polyamides; polyacrylonitriles and polymethacrylonitriles; perfluorinated and partially fluorinated polymers (e.g., polytetrafluoroethylene, copolymers of tetrafluoroethylene and polystyrenes, and the like); polycarbonates; polyvinyl chlorides; polyurethanes; polyacrylic resins, including homopolymers and copolymers of esters of acrylic or methacrylic acids; epoxy resins; Novolac resins, organic charge transfer compounds (e.g., tetrathiafulvalene tetracyanoquinodimethane (“TTF-TCNQ”) and the like), any combination thereof, and the like.

After selecting a material, skilled artisans appreciate that the thickness of the material can be tailored to achieve low L_{background} using the equations previously described. Although the calculations can yield a single thickness, typically a range of acceptable thicknesses may be given for manufacturing reasons. As long as the thickness does not lie outside the range, reasonably acceptable L_{background} may be achieved.

Skilled artisans appreciate that they may be able to achieve L_{background} without having to change the composition of materials for the electronic device layers. Such a change could cause problems with device performance, problems with processing or materials incompatibility, an entire re-design of the electronic device, or the like. The thicknesses for layers can be chosen to give acceptable electrical and radiation-related performance. For example, electrodes may have a minimum thickness determined by resistance, electromigration, or other device performance or reliability reasons. The maximum thickness may be limited by step-height concerns, such as step coverage or lithography constraints for subsequently formed layers. Still, the range between the minimum and maximum thicknesses for an electrode layer may allow a plurality of thicknesses to be chosen that still give L_{background} while achieving the proper device performance.

Attention is now directed to details for a first set of embodiments that is shown in FIGS. 8-13 in which high contrast can be achieved by using a black lattice or a black lattice in combination with a black layer. The materials used for the electronic device layers are typically determined by the desired performance criteria that are related to electronic and radiation (emitted or received by an active layer) constraints. Additional constraints related to physical limitations (thicknesses and widths of features and spaces) may also be considered.

In a first embodiment, anode strips 22 may be formed over a substrate 10 as illustrated in FIG. 8. The substrate 10 can include nearly any type and number of materials including conductive, semiconductive, or insulating materials. If substrate 10 includes a conductive base material, care may need to be exercised to ensure the proper electrical isolation between parts of a component. The conductive base material may be covered by an insulating layer having a sufficient thickness to reduce the effects of parasitic capacitance between overlying electrodes or conductors and the underlying conductive base material. Skilled artisans are capable of determining an appropriate thickness of an insulating layer to reduce the effects of undesired capacitive coupling.

The substrate 10 may comprise a ceramic material (e.g., glass, alumina, or the like) or a flexible substrate comprising at least one polymeric film. Examples of suitable polymers for the polymeric film may be selected from one or more materials containing essentially polyolefins (e.g., polyethylene, polypropylene, or the like); polyesters (e.g., polyethylene terephthalate, polyethylene naphthalate or the like); polyimides; polyamides; polyacrylonitriles and polymethacrylonitriles; perfluorinated and partially fluorinated polymers (e.g., polytetrafluoroethylene, copolymers of tetrafluoroethylene and polystyrenes, and the like); polycarbonates; polyvinyl chlorides; polyurethanes; polyacrylic resins, including homopolymers and copolymers of esters of acrylic or methacrylic acids; epoxy resins; Novolac resins; any combination thereof; and the like. When multiple films are used, they can be joined together with appropriate adhesives or by conventional layer producing processes including known coating, co-extrusion, or other similar processes. The polymeric films generally have a thickness in the range of approximately 12-250 microns (0.5-10 mils). When more than one film layer is present, the individual thicknesses can be much less.

Although the polymeric film(s) may contain essentially one or more of the polymers described above, the film(s) may also include one or more conventional additive(s). For example, many commercially available polymeric films contain slip agents or matte agents to prevent the layers of film from sticking together when stored as a large roll.

For flexible substrates that include a plurality of polymeric films, at least one layer of barrier material may be sandwiched between at least two of the polymeric films. In one non-limiting example, a polyester film approximately 25-50 microns (1-2 mils) thick can be coated with an approximately 2-500 nm thick layer of silicon nitride (SiNₓ) using plasma enhanced chemical vapor deposition or physical vapor deposition (conventional rf magnetron sputtering or inductively-coupled plasma physical vapor deposition (ICP-PVD). The silicon nitride layer can then be overcoated with a solution of acrylic resin that is allowed to dry, or an epoxy or Novolac resin followed by curing. Alternatively, the silicon nitride coated polyester film can be laminated to a second layer of polyester film. The overall thickness of the composite structure is generally in the range of approximately 12-250 microns (0.5-10 mils), and more typically 25-200 microns (1-8 mils). Such overall thickness can be affected by the method used to apply or lay down the composite structure.

After reading this specification, skilled artisans appreciate that the selection of material(s) that can be used for the substrate 10 is widely varied. Skilled artisans are capable of selecting the appropriate material(s) based on their physical, chemical, and electrical properties. For simplicity, the material(s) used for this base are referred to as substrate 10.

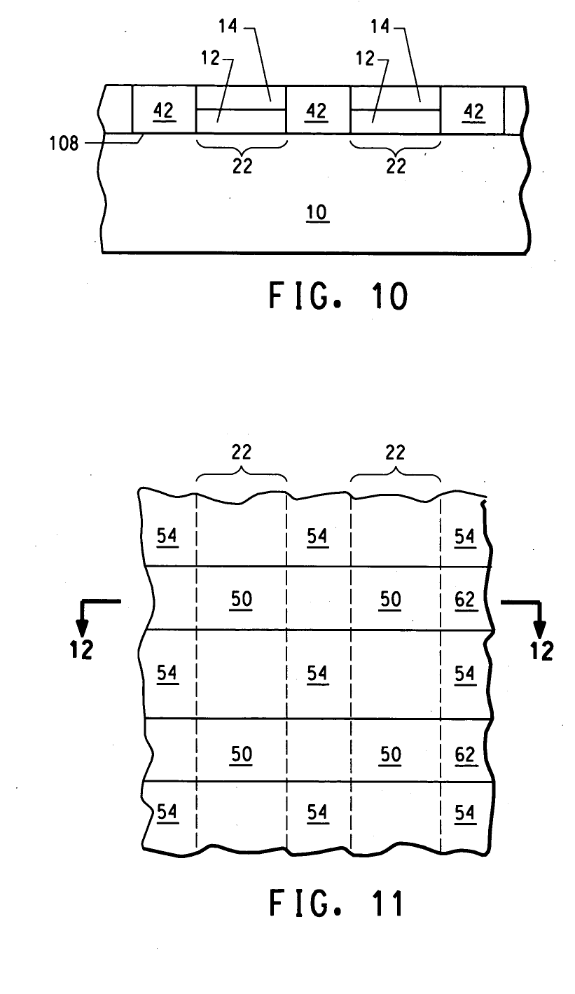

The anode strips 22 may include a conductive black layer 12 and a high work function material 14 as shown in FIG. 9. The conductive black layer 12 can include nearly any conductive material. The black layer 12 should have good transmission because radiation needs to pass through the black layer 12 during the operation of the electronic device. Equations 2 and 3 may be used to reduce the effects of reflectivity while still maintaining reasonable transmission. In simplifying calculations, only the single layer reflectance (Equation 2) may be used. In other embodiments, reflectance at only selected interfaces with already existing and subsequently formed layers may be considered.

The high work function material 14 can include a metal, mixed metal, alloy, metal oxide or mixed-metal oxide. Suitable metal elements within the anode layer can include the Groups 4, 5, 6, and 8-11 transition metals. If the high work function material 14 is to be light transmitting, mixed-metal oxides of Groups 12, 13 and 14 metals, such as indium-tin-oxide, may be used. Some non-limiting, specific examples of materials for the high work function material 14 include indium-tin-oxide (“ITO”), aluminum-tin-oxide, gold, silver, copper, nickel, and selenium. The anode strips 22 may have a thickness in a range of approximately 10-1000 nm.

A black lattice 42 can be formed over the substrate 10 between the anode strips 22 as shown in FIG. 10. Unlike the black conductive layer 12, radiation does not need to be transmitted through the black lattice 42. In one embodiment, the black lattice 42 may include a negative-acting resist layer that may include a dye or other chemical to achieve relatively high absorbance of the targeted radiation for the electronic device. Other radiation-imageable materials (e.g. positive-acting photoresist, photo-imageable polyimide, etc.) may be used instead of the negative-acting resist layer. Absorbance may be substantially more significant in reducing L_{background} compared to reflectivity. As long as the thickness is above a minimum threshold to achieve the desired absorbance, the thickness can be nearly any thickness above a lower limit. For example, if the thickness for minimum threshold absorbance is 50 nm, black lattice 42 may have nearly any thickness at or above 50 nm.

Returning to FIG. 10, the thickness of the negative-acting black lattice 42 can be similar to the combined thicknesses of layers 12 and 14, although this is not a requirement. After patterning, the portions of the black lattice 42 lie in the spaced-apart regions between the anode strips 22. The portions of the black lattice 42 are electrical insulators between the conductive members and may reduce the likelihood of electrical shorts or conduction paths between adjacent anode strips 22. Also, the portions of black lattice 42 can reduce optical cross talk because the black lattice 42 has high absorbance. In this particular embodiment, the portions of the black lattice 42 do not overlie or underlie the anode strips 22. The anode strips 22 and the black lattice 42 lie at substantially the same elevation.

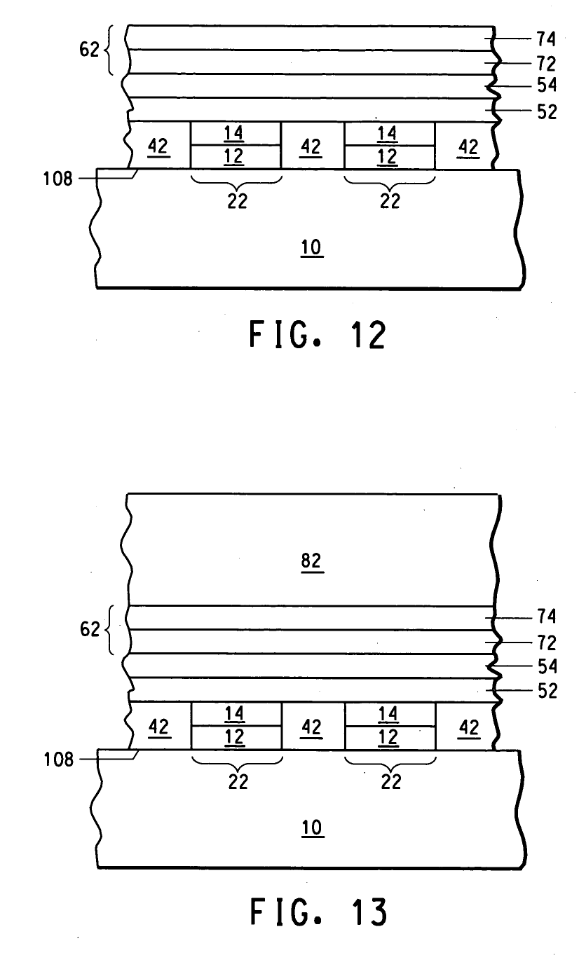

An optional hole-transport layer 52, organic active layer 54, and cathode strips 62 may be sequentially formed over the high work function material 14 and the black lattice 42 as shown in FIGS. 11 and 12. FIG. 11 includes a top view of the structure, and FIG. 12 includes a cross-sectional view of the structure at sectioning line 12-12 in FIG. 11.

The hole-transport layer 52 can be used to reduce the amount of damage and potentially increase the lifetime and reliability of the device compared to a device where layer 14 would directly contact a subsequently formed active layer. In one specific embodiment, the hole-transport layer 52 can include an organic polymer, such as polyaniline (“PANI”), poly(3,4-ethylenedioxythiophene) (“PEDOT”), and the like, or an organic charge transfer compound, such as TTF-TCQN and the like. Layer 52 typically has a thickness in a range of approximately 30-500 nm.

The hole-transport layer 52 typically is conductive to allow electrons to be removed from the subsequently formed active region and transferred to material 14. Although anode strips 22 and the optional hole-transport layer 52 are conductive, typically the conductivity of the anode strips 22 is significantly greater than the hole-transport layer 52.

Depending upon the application of the electronic device, the organic active layer 54 can be a radiation-emitting layer that is activated by a signal (such as in a light-emitting diode), or a layer of material that responds to radiant energy and generates a signal with or without an applied potential (such as in a photodetector). Examples of electronic devices that may respond to radiant energy are selected from light-emitting displays, photoconductive cells, photoresistors, photoswitches, phototransistors, phototubes, and photovoltaic cells. After reading the specification, skilled artisans will appreciate that other similar electronic devices may operate outside the visible light spectrum, such as infrared, ultraviolet, and the like.

When the organic active layer 54 is within a radiation-emitting electronic device, the layer will emit radiation when sufficient bias voltage is applied to the electrical contact layers. The organic active layer may contain nearly any organic electroluminescent or other organic radiation-emitting materials.

Such active layer materials can be small molecule materials (including phosphorescent and fluoroescent materials) or polymeric materials, and mixtures thereof. Small molecule materials may include those described in, for example, U.S. Pat. No. 4,356,429 (“Tang”) and U.S. Pat. No. 4,539,507 (“Van Slyke”), the relevant portions of which are incorporated herein by reference. Alternatively, polymeric materials may include those described in U.S. Pat. No. 5,247,190 (“Friend”), U.S. Pat. No. 5,408,109 (“Heeger”), and U.S. Pat. No. 5,317,169 (“Nakano”), the relevant portions of which are incorporated herein by reference. Exemplary materials are semiconductive conjugated polymers. An example of such a polymer is poly(phenylenevinylene) referred to as “PPV.” The organic active layer materials may optionally be dispersed in a matrix of or in solution with another material, with or without additives. The active layer generally has a thickness in the range of approximately 50-500 nm. One or more radiation-emitting materials may be used to form the active layer.

When the organic active layer 54 is incorporated in a radiation detector or current generator, the layer responds to radiant energy and produces a signal or current either with or without a biased voltage. Materials that respond to radiant energy and are capable of generating a signal or current with a biased voltage include, for example, many conjugated polymers and other photo- and electro-luminescent materials. Materials that respond to radiant energy and are capable of generating a signal or current without a biased voltage (such as in the case of a photoconductive cell or a photovoltaic cell) include materials that react to radiation and generate electron-hole pairs. The electrons or holes can be used in generating a signal or current. Such organic active layer charge generating materials include for example, many conjugated polymers and other organic electro- and photo-luminescent materials. Specific examples include, but are not limited to, poly(2-methoxy,5-(2-ethyl-hexyloxy)-1,4-phenylene vinylene) (“MEH-PPV”) and MEH-PPV composites with CN-PPV.

Additional illustrative organic active layer materials include, but are not limited to, polyfluoroene or a metal containing small molecule materials such as luminescent lanthanide complexes with phosphine oxides, phosphine oxide sulfides, pyridine N-oxides, phosphine oxide-pryridine N-oxides; Iridium compounds with fluorinated phenylpyridines, phenylpyrimidines, and phenylquinolines; and Platinum compounds, and mixtures of more than one active materials.

A layer containing the organic active material can be applied over the hole-transport layer 52 from solution using a conventional means, including spin-coating, casting, and printing. The organic active materials can be applied directly by vapor deposition processes, depending upon the nature of the materials. An active polymer precursor can be applied and then converted to the polymer, typically by heating. The active layer 54 typically has a thickness in a range of approximately 50-500 nm.

The hole-transport layer 52 and organic active layer 54 may be patterned using a conventional technique to remove portions of the layers 52 and 54 where electrical contacts (not shown) are subsequently made. Typically, the electrical contact areas are near the edge of the array or outside the array to allow peripheral circuitry to send or receive signals from the array.

The cathode strips 62 may include at least one of the materials that were described with respect to the anode strips 22. The cathode strips 62 are electrodes that provide a source of electrons that are injected into the active layer 54. In this specific embodiment, the cathode strips 62 comprise a low work function material 72 and a conductive layer 74 that helps to provide good conductivity. The low work function material 72 can be selected from Group 1 metals (e.g., Li, Cs, or the like), the Group 2 (alkaline earth) metals, the rare earth metals including the lanthanides and the actinides, and the like. Other materials, such as aluminum, silver, or the like can be used. Conductive polymers with low work functions may also be used.

A thickness chosen for the cathode strips 62 may be a function of a number of factors. If no radiation is to pass from the cathode side of the electronic device, the materials used and their thicknesses can be chosen without regard to the transmission of radiation. If radiation is to be transmitted to or from the cathode side of the device, the composition and thickness of layers 72 and 74 may be chosen to allow radiation to pass through it.

Similar to the black conductive layer 12 in the anode strips 22, the cathode strips 62 may include a black conductive layer that can replace or be used in conjunction with layer 74. If a black conductive layer is used with the cathode strips 62, its location may be farthest from the organic active layer 54 compared to any other layer within the cathode strips 62. The composition and thickness that can be used for the black conductive layer for the cathode strips may be determined using the same or similar consideration as with the black conductive layer 12 of the anode strips 22.

In many applications, the thickness of the cathode strips 62 may be in a range of approximately 5-500 nm. If radiation is not to be transmitted through the cathode, the upper limit on the thickness may be extended.

As seen in FIG. 11, the lengths of the cathode strips 62 are substantially parallel to one another and are substantially perpendicular to the lengths of the anode strips 22 illustrated by dashed lines in FIG. 11. In FIG. 11, the cathode strips 62 and the organic active layer 54 are exposed. The intersections of each pair of anode strips 22 and cathode strips 62 define the device regions 50. Within each of the device regions 50, the active layer 54 lies between the electrodes 22 and 62. Four device regions 50 are illustrated in FIG. 12.

Other circuitry not illustrated in FIGS. 8-12 may be formed using any number of the previously described or additional layers. Although not shown, additional insulating layer(s) and interconnect level(s) may be formed to allow for circuitry in peripheral areas (not shown) that may lie outside the array. Such circuitry may include row or column decoders, strobes (e.g., row array strobe, column array strobe, or the like), sense amplifiers, or the like.

A shielding layer 82 can be formed over the array and its devices as illustrated in FIG. 13 to form a substantially completed electrical component, such as an electronic display, a radiation detector, a voltaic cell, and the like. The peripheral circuitry is conventional and known to skilled artisans. The shielding layer typically lies on a side opposite the user side of the electronic device. Radiation may be transmitted through the shielding layer 82. If so, the shielding layer should be transparent to the radiation.

The first set of embodiments have advantages in that one or more black layers or lattices can be incorporated within an electronic device without the need of adding a layer that may complicate the electronic structure or simulations of its performance. Also, a large number of materials can be used for high absorbance layers. A change in materials for the electronic device may not be needed, and therefore, new material compatibility issues may not arise. Also, from an electronic performance standpoint, some layers may not be too sensitive to thickness and a plurality of thicknesses may be used for a layer to allow it to have the proper electrical and optical properties.

In other embodiments, the black lattice may be formed between the cathodes or another black lattice may be formed between the cathode strips 62. Note that the black lattice could lie between any of the layers within the electronic device. Therefore, most of the black lattice may lie at elevations between the anode strips 22 and the cathode strips 62. For example, the black lattice could lie between the anode strips 22 and the hole-transport layer 52, between the hole-transport layer 52 and the organic active layer 54, or between the organic active layer 54 and the cathode strips 62. After reading this specification, skilled artisans will appreciate that the black lattice or black lattices may be formed at many different levels within the electronic device.

In still another embodiment, the black lattice may be formed before forming device structures at the same elevation. Referring to FIG. 10, the black lattice could be formed over the substrate 10 before the anode strips 22 are formed. In still a further embodiment, the black lattice may be formed in a pattern that defines pixels. For example, a black lattice 220 similar to the one shown in FIG. 2 may be formed to define the openings 240 over substrate 10 and anode strips 22. The black lattice 220 may have high absorbance. The hole-transport layer 52 and organic active layer 54 may be formed only within the openings 240. This embodiment may allow for less optical cross talk between rows compared to an embodiment where the black lattice is formed as a series of strips.

In still another embodiment, the black lattice may correspond to the thickness of only one layer. For example, the thickness of the black lattice 42, shown in FIG. 10, may be similar to the thickness of the conductive layer 12, rather than the thickness of the anode strips 22.

Note that the black conductive layer 12 and black lattice 42 lie at substantially the same elevation. From the user side of the electronic device (i.e., at substrate 10), the entire surface of the array may be covered by black features (black layer 12 and black lattice 42) and obviate the need to use black features at other elevations within the device.

In still other embodiments, the anode and cathode can be reversed. If radiation is to pass through the cathode, the conductive layer(s) of the cathode may need to have its (their) thickness(es) adjusted so that the proper intensity of radiation passes through the conductive layer(s) when the radiation is to be emitted from or received by the active layer 54.

In an alternative embodiment, a black layer, black lattice, or both may be used on both sides of an electronic device. Such a configuration may be useful if opposite sides of the array are user sides.

During operation of a display, appropriate potentials are placed on the anode and cathode to cause radiation to be emitted from the active layer 54. More specifically, when light is to be emitted, a potential difference between the anode and cathode electrodes allow electron-hole pairs to combine within the active layer 54, so that light or other radiation may be emitted from the electronic device. In a display, rows and columns can be given signals to activate the appropriate pixels (electronic devices) to render a display to a viewer in a human-understandable form.

During operation of a radiation detector, such as a photodetector, sense amplifiers may be coupled to the anodes and cathodes of the array to detect significant current flow when radiation is received by the electronic device. In a voltaic cell, such as a photovoltaic cell, light or other radiation can be converted to energy that can flow without an external energy source. After reading this specification, skilled artisans are capable of designing the electronic devices, peripheral circuitry, and potentially remote circuitry to best suit their particular needs.

Embodiments as described herein can be adapted to many applications and provide a cost-effective, manufacturable solution to provide relatively higher contrast compared to conventional organic electronic devices. The embodiments allow existing materials within an electronic device to be used without the replacement of current materials or insertion of new layers within the electronic device regions. The ability to use the current materials simplifies integration of a high absorbance layer into the electronic device and reduces the likelihood of device re-design, materials compatibility or device reliability issues. The embodiments obviate the need for a circular polarizer. Additionally, the black lattice or layer may be integrated into a process without significant complications or adverse consequences.

### EXAMPLES

The following specific examples are meant to illustrate and not limit the scope of the invention. In these examples, the electronic devices are organic light-emitting diodes (OLED) that are pixels for a display. Many of the thicknesses given in the examples below represent nominal thicknesses

### Example 1

Example 1 illustrates that a black lattice using a high absorbance material can both increase the contrast and reduce both the radiating and electrical cross talk among electronic devices. In this example, a black lattice is used to reduce L_{background} and improve CR (Equation 1) by a factor of about two.

A typical polymer LED is fabricated following well-known procedures. Glass/ITO can be used as substrate and transparent anode. A thin layer of PANI or PEDOT is spin-cast on the substrate, followed by spin-casting an electroluminescent (EL) layer. A thin layer of metal Ba/Al is vacuum deposited on top of EL layer and serves as the cathode. The color of the PLED device depends on the opto-electronic properties of the EL material. The black lattice is fabricated on another glass substrate using photolithography technology. The black lattice could also be fabricated on the device glass substrate. The black lattice is Cr metal which is thick enough to absorb substantially all the incident light. The microstructure of the black lattice is similar to that illustrated in FIG. 2. The size of each transparent pixel is approximately 75 μm×275 μm. The ratio of transparent area to the black area is about 70%. The black lattice panel can be laminated on top of the transparent side of the device. Without the black lattice panel, the contrast ratio is about 15:1. With the black lattice panel, the contrast ratio is enhanced to 33:1. Three PLED devices with different emitting colors, blue, green and red, are tested with the same black lattice panel. Similar results can be obtained for each device. This specific black lattice panel enhances the contrast ratio by a factor of 2. Therefore, at least 50% incident ambient light should be absorbed by the black lattice, while only 30% of emitting light is blocked.

### Example 2

Example 2 illustrates that a black lattice can be formed on a substrate using a pattern that at least partially surrounds anodes or cathodes. The black lattice fabricated in this way can: 1) enhance the contrast; and 2) eliminate both optical and electronic cross talk between pixels.

Glass can be used as a substrate. ITO and black photoresist are used as the anode contact and black lattice and are prepared by photolithography in sequence. The ITO is patterned using positive photoresist, and then etching of the ITO. The black lattice is patterned using negative black photoresist. In this example, the black lattice is made as thick as the ITO layer. The lateral dimensions of the black strips are the same as those in Example 1. In fabricating a light emitting device, a thin, transparent PANI or PEDOT layer is spin-cast on the substrate with thickness varied in a range of approximately 30 nm-500 nm. Three different PPV derivatives with EL emission covering the visible ranges can be used as the EL layer in three different devices. The thicknesses are approximately 70 nm. Ba(3 nm)/Al(300 nm) can be used as the cathode layer. A contrast improvement by a factor of about 2, as obtained in Example 1, can be observed for all three different color OLED devices.

For high pixel content information displays, the black lattice could be constructed to surround each pixel as illustrated in FIG. 6, and an additional black lattice panel (demonstrated in Example 1) could be integrated to enhance the contrast more.

### Example 3

Example 3 illustrates that OLEDs with black anodes can be fabricated following a similar procedure described in Example 2. This example demonstrates that high display contrast can be obtained with polarizer-less, multicolor organic display with a black anode.

Glass/Cr/ITO, glass/Ta/ITO, or glass/Si can be used as the substrate and anode, and the anode layers (Cr, Ta, Si, ITO) are prepared by thermal evaporation, MOCVD and PECVD. The reflectivity or transmittance of the anode can be adjusted by the thickness of Cr, Ta, and Si with a light transmission over ˜10%. A thin, transparent PANI layer can be spin-cast with thickness varied in range of 30-500 nm. Three PPV derivatives with EL emission covering the visible ranges is used as the EL layer in three different devices. Their thicknesses are approximately 70 nm. Ba(3 nm)/Al(300 nm) can be used as the cathode layer. A contrast ratio of approximately 100:1 may be obtained for all three different color devices.

### Example 4

Example 4 illustrates that OLEDs having black cathodes can be fabricated following a similar procedure as used in Example 3. This example demonstrates that high contrast can be obtained with polarizer-less OLED using a black cathode. A contrast of 50:1 is obtained in an OLED device of the structure ITO/PANI/PPV/Ba/Al/Cr.

Several EL polymers that emit in the visible range may be used as the emission layers. The thicknesses of the EL layers are approximately 70˜80 nm. Ba/Al/Cr can be used as the cathode layer with thicknesses of approximately 2 nm, 10 nm and 200 nm, respectively.

The contrast of this polarizer-less OLED with a black cathode is approximately 50:1. For comparison, the optical contrast of an OLED with the same device structure, but using a traditional metal cathode is approximately 15:1 (without a circular polarizer) and 400:1 (with a circular polarizer).

High contrast devices have also been demonstrated when a black absorption layer, either conductive or non-conductive, is coated over (or underneath) the ITO layer. For example, an OLED having a structure of ITO/PANI/ELP/Ba(2 nm)/Al(10 nm)/ITO/carbon.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of the invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims.

What is claimed is:

1. An array of electronic devices comprising:
anodes lying at a first elevation;
cathodes lying at a second elevation;
an organic active material lying between the anodes and cathodes; and
a high absorbance material lying at any elevation from the first elevation to the second elevation.

2. The array of claim 1, wherein:
the high absorbance layer lies at the first elevation.

3. The array of claim 1, wherein:
the array is a passive matrix array;
an electrode selected from the anodes and cathodes comprises a first pair of opposing sides; and
the high absorbance material includes portions lying along the first pair of opposing sides.

4. The array of claim 1, wherein:
the array is an active matrix array; and
the high absorbance material surrounds an electrode selected from the anodes and cathodes.

5. The array of claim 1, wherein a set of electrodes selected from the anodes and the cathodes comprises a low reflectivity layer.

6. The array of claim 5, wherein, a reflectivity at an interface or a range of thicknesses for the low reflectivity layer is determined by at least one of Equation 2 and Equation 3, wherein:
2ηd cos(θ)+φ=(m+½)/λ (Equation 2)
wherein:
η is a refractive index of a material of the low reflectivity layer at a specific wavelength (λ);
d is a thickness of the low reflectivity layer;
θ is an angle of incident radiation;
φ is a total phase change of radiation reflected by an ideal reflector at λ;
m is an integer; and
λ is the specific wavelength; and
$$R = \frac{{I}_{reflected}}{{I}_{incident}} = {( \frac{{η}_{x} - {η}_{y}}{{η}_{x} + {η}_{y}} )}^{2} \qquad ( Equation 3 )$$
wherein ηₓ and η_{y} are refractive indices of the materials on opposite sides of an interface lying at an edge of the low reflectivity layer.

7. The array of claim 1, wherein the high absorbance material is an electrical insulator lying between a set of electrodes selected from the anodes and the cathodes.

8. The array of claim 1, wherein most of the high absorbance material lies at elevations between the anodes and the cathodes.

9. The array of claim 1, wherein the organic active material comprises a conjugated polymer.

10. The array of claim 1, further comprising a substrate and a hole-transport layer, wherein:
the anodes and the high absorbance material contact the substrate;
the high absorbance material comprises a radiation-imageable material; and
the hole-transport layer lies between the anodes and the organic active material.

11. A display comprising the array of claim 1.

12. A detector comprising the array of claim 1.

13. A voltaic cell comprising the array of claim 1.

14. An array of electronic devices comprising:
anodes lying at a first elevation;
cathodes lying at a second elevation;
an organic active material lying between the anodes and cathodes; and
a first feature lying at any elevation from the first elevation to the second elevation, wherein the array has an Ambient Contrast Ratio, when using the experimental set-up and procedures detailed in “Flat Panel Display Measurements Standard” by the Video Electronics Standards Association Display Metrology Committee, that is at least approximately 50% higher compared to a same array without the first feature.

15. The array of claim 14, wherein the first feature comprises a low reflectivity layer lying at an elevation selected from the first elevation and the second elevation.

16. The array of claim 14, wherein the first feature comprises a high absorbance material lying at an elevation selected from the first elevation and the second elevation.

17. The array of claim 16, wherein a set of electrodes selected from the anodes and the cathodes comprises a second feature, wherein the second feature comprises a low reflectivity layer.

18. The array of claim 17, wherein, a reflectivity at an interface or a range of thicknesses for the low reflectivity layer is determined by at least one of Equation 2 and Equation 3, wherein:
2ηd cos(θ)+φ=(m+½)/λ (Equation 2)
wherein:
η is a refractive index of a material of the low reflectivity layer at a specific wavelength (λ);
d is a thickness of the low reflectivity layer;
θ is an angle of incident radiation;
φ is a total phase change of radiation reflected by an ideal reflector at λ;
m is an integer; and
λ is the specific wavelength; and
$$R = \frac{{I}_{reflected}}{{I}_{incident}} = {( \frac{{η}_{x} - {η}_{y}}{{η}_{x} + {η}_{y}} )}^{2} \qquad ( Equation 3 )$$
wherein ηₓ and η_{y} are refractive indices of the materials on opposite sides of an interface lying at an edge of the low reflectivity layer.

19. The array of claim 14, wherein:
the array is a passive matrix array;
at least one of the anodes comprises a first pair of opposing sides; and
the first feature includes portions lying along the first pair of opposing sides.

20. The array of claim 14, wherein:
the array is an active matrix array; and
the portions of the first feature surround an electrode selected from the anodes and the cathodes.

21. The array of claim 14, wherein most of the first feature lies at elevations between the anodes and the cathodes.

22. The array of claim 14, wherein the first feature is an electrical insulator lying between a set of electrodes selected from the anodes and the cathodes.

23. The array of claim 14, wherein the organic active material comprises a conjugated polymer.

24. A device comprising the array of claim 14, said device selected from the group of light-emitting displays, radiation sensitive devices, photoconductive cells, photoresistors, photoswitches, photodetectors, phototransistors, and phototubes.

25. An array of electronic devices comprising:
anodes at a first elevation;
cathodes at a second elevation;
an organic active material lying between the anodes and cathodes; and
a black lattice,
wherein a set of electrodes selected from the anodes and cathodes includes a black layer lying at a substantially same elevation as the black lattice.

26. The array of claim 25, wherein the black lattice comprises a high absorbance material.

27. The array of claim 25, wherein:
the array is a passive matrix array;
at least one of the anodes comprises a first pair of opposing sides; and
the black lattice includes portions lying along the first pair of opposing sides.

28. The array of claim 25, wherein:
the array is an active matrix array; and
the portions of the black lattice surround an electrode selected from anodes and cathodes.

29. The array of claim 25, wherein the black layer comprises a low reflectivity layer.

30. The array of claim 29, wherein, a reflectivity at an interface or a range of thicknesses for the low reflectivity layer is determined by at least one of Equation 2 and Equation 3, wherein:
2ηd cos(θ)+φ=(m+½)/λ (Equation 2)
wherein:
η is a refractive index of a material of the low reflectivity layer at a specific wavelength (λ);
d is a thickness of the low reflectivity layer;
θ is an angle of incident radiation;
φ is a total phase change of radiation reflected by an ideal reflector at λ;
m is an integer; and
λ is the specific wavelength; and
$$R = \frac{{I}_{reflected}}{{I}_{incident}} = {( \frac{{η}_{x} - {η}_{y}}{{η}_{x} + {η}_{y}} )}^{2} \qquad ( Equation 3 )$$
wherein ηₓ and η_{y} are refractive indices of the materials on opposite sides of an interface lying at an edge of the low reflectivity layer.

31. The array of claim 25, wherein the organic active material comprises a conjugated polymer.

32. The array of claim 25, wherein the black lattice is an electrical insulator lying between electrodes selected from the anodes and the cathodes.

33. A device comprising the array of claim 25, said device selected from the group of light-emitting displays, radiation sensitive devices, photoconductive cells, photoresistors, photoswitches, photodetectors, phototransistors, and phototubes.

34. A process for forming an array of electronic devices comprising:
forming anodes lying at a first elevation;
forming cathodes lying at a second elevation;
forming an organic active material between forming the anodes and forming cathodes; and
forming a high absorbance material lying at any elevation from the first elevation to the second elevation.

35. The process of claim 34, wherein forming the high absorbance layer comprises forming the high absorbance layer at the first elevation.

36. The process of claim 34, wherein:
the array is a passive matrix array;
an electrode selected from the anodes and cathodes comprises a first pair of opposing sides; and
the high absorbance material includes portions lying along the first pair of opposing sides.

37. The process of claim 34, wherein:
the array is an active matrix array; and
the high absorbance material surrounds an electrode selected from the anodes and cathodes.

38. The process of claim 34, wherein forming a set of electrodes is selected from forming the anodes and forming the cathodes, wherein forming the set of electrodes comprises forming a low reflectivity layer.

39. The process of claim 38, wherein, a reflectivity at an interface or a range of thicknesses for the low reflectivity layer is determined by at least one of Equation 2 and Equation 3, wherein:
2ηd cos(θ)+φ=(m+½)/λ (Equation 2)
wherein:
η is a refractive index of a material of the low reflectivity layer at a specific wavelength (λ);
d is a thickness of the low reflectivity layer;
θ is an angle of incident radiation;
φ is a total phase change of radiation reflected by an ideal reflector at λ;
m is an integer; and
λ is the specific wavelength; and
$$R = \frac{{I}_{reflected}}{{I}_{incident}} = {( \frac{{η}_{x} - {η}_{y}}{{η}_{x} + {η}_{y}} )}^{2} \qquad ( Equation 3 )$$
wherein ηₓ and η_{y} are refractive indices of the materials on opposite sides of an interface lying at an edge of the low reflectivity layer, and.

40. The process of claim 34, wherein the high absorbance material is an electrical insulator lying between a set of electrodes selected from the anodes and the cathodes.

41. The process of claim 34, wherein forming the high absorbance material comprises forming the high absorbance material so that most of the high absorbance material lies at elevations between the anodes and the cathodes.

42. The process of claim 34, wherein the organic active material comprises a conjugated polymer and small molecules and mixtures thereof.

43. The process of claim 34, wherein:
forming the anodes is performed before forming the high absorbance material;
the anodes and the high absorbance material contact a substrate;
the high absorbance material comprises a radiation-imageable material; and
the process further comprises forming a hole-transport layer after forming the anodes and before forming the organic active material.

44. A device comprising the array made by the process of claim 34, said device selected from the group of light-emitting displays, radiation sensitive devices, photoconductive cells, photoresistors, photoswitches, photodetectors, phototransistors, and phototubes.
